(19) United States
(12) Patent Application Publication
(10) Pub. No.: US 2020/0238834 A1
(43) Pub. Date: Jul. 30, 2020

(54) ACTIVE CONTROL OF A CURRENT COLLECTOR

(71) Applicant: KNORR-BREMSE GMBH, Mödling (AT)

(72) Inventors: Andreas SCHUNKE, Hardegen (DE); Manfred VOHLA, Wein (AT)

(21) Appl. No.: 16/755,472

(22) PCT Filed: Oct. 9, 2018
(86) PCT No.: PCT/EP2018/077480

§ 371 Date: Apr. 10, 2020

(30) Foreign Application Priority Data
Oct. 10, 2017 (DE) 10 2017 218 056.0

(51) Int. Cl. B60L 5/20; B61L 27/00

(52) U.S. Cl. CPC B60L 5/20; B61L 27/0094; B61L 27/0088

(57) ABSTRACT

The invention relates to a device comprising a sensor device for detecting a current operating state of an electrically conductive connection or a contact between a movable and a stationary part of an electric current supply, e.g. a contact between an overhead line and a current collector, in order to control a contact force. The invention also relates to a method using such a device.

### CROSS REFERENCE AND PRIORITY

This patent application is a U.S. National Phase of International Patent Application No. PCT/EP2018/077480 filed Oct. 9, 2018, which claims priority to German Patent Application No. 10 2017 218 056.0, the disclosure of which being incorporated herein by reference in their entireties.

### FIELD

Disclosed embodiments relate to a device for identifying a current operating state of an electrically conductive connection or a contact between a moveable and a stationary part of an electric current supply, e.g. a contact between a contact line and a current collector, to regulate a contact force, and to a method using such a device.

### BACKGROUND

In particular, disclosed embodiments are applicable in current collectors of electric locomotives, which require a specific contact force with the contact line. In the present case, the contact line is an overhead line of conventional design, or of innovative design, e.g. overhead conductor rails.

If this contact force is too low, the current collector will begin to jump. The resulting contact interruptions and arcing compromise the service life of current collector rockers and contact lines. If this contact force is too great, the contact line will be raised to an inordinate degree. In the event of unacceptable introduction of forces into the contact line, the mechanical positioning thereof cannot be ensured, and a “threading” of the current collector and the pulling down of the contact line are typical consequences.

### SUMMARY

Disclosed embodiments provide a cost-effective device and of a method using such a device, by which a current operating state of an electrically conductive connection or of a contact between a moveable and a stationary part of an electric current transfer system can be identified and evaluated. In particular, by the application of the disclosed embodiments in a current collector of a vehicle, it is intended that e.g. contact strip wear on a current collector rocker be minimized by combined optimization of electrical and mechanical wear. This may be achieved in that the contact strips of the current collector rocker, in the interests of minimum mechanical wear, are operated within a range of limited and minimal contact force, with no resulting increased electrical wear associated with arcing and sparkover caused by impairments in current transmission.

### BRIEF DESCRIPTION OF THE FIGURES

Disclosed exemplary embodiments are described in greater detail hereinafter, with reference to the figures. In the figures:

FIG. 1 shows the requisite contact force in accordance with the vehicle speed, according to the prior art;

FIG. 2 shows a schematic representation of a current collector, employing a device according to an exemplary embodiment;

FIG. 3 shows a flow diagram for a control logic of the device according to an exemplary embodiment.

### DETAILED DESCRIPTION

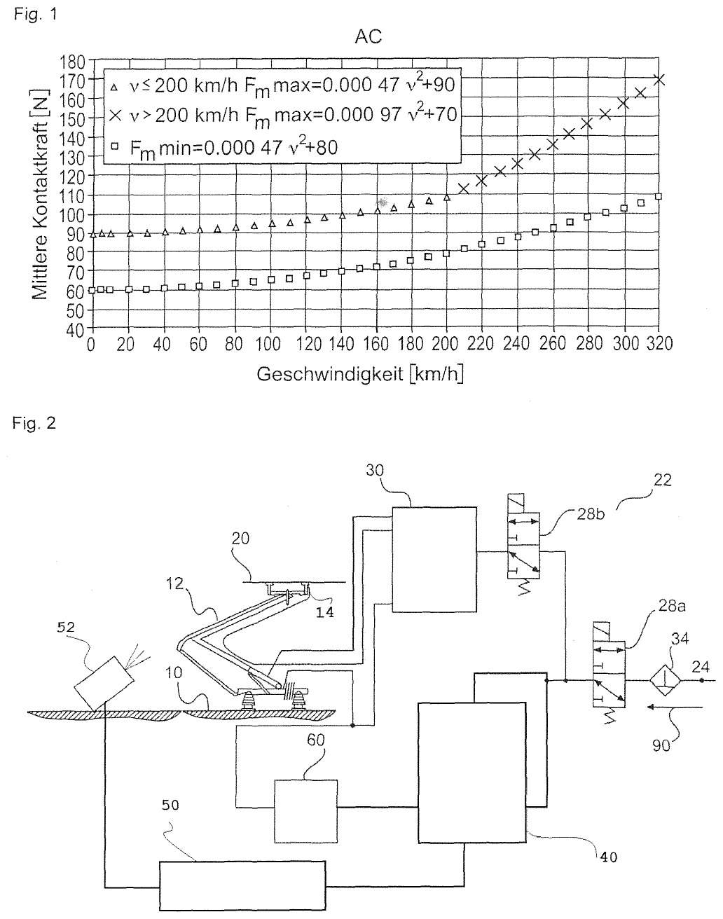

According to DIN EN 50637:2012, particularly in high-speed operation (>200 km/h), the requisite contact forces rise steeply to approximately double the stationary value, as shown in FIG. 1. To ensure this increase, according to the prior art, wind deflectors are employed in the current collector, which firstly deliver an additional aerodynamic force, and secondly offset any dynamic lifting forces. Disadvantageously, the design and operation of these wind deflectors are not easily adaptable to different operating situations. For example, the additional aerodynamic force in high-speed tunnels is significantly greater than on open track. However, this additional force is also dependent upon the vehicle shape, the tunnel cross-section, the blockage factor (the ratio of the vehicle cross-section to the tunnel cross-section), abrupt changes in cross-section and the position of the current collector in the train formation. This additional force is also dependent upon the direction of travel (for example, depending upon the rear-facing or front-facing articulation of an asymmetrical single-leg current collector).

Moreover, it is increasingly required that the stationary current collector contact force should be raised, to prevent any overheating and damage to the contact strip and the contact line at the point of contact in the event of a high current flux associated with lighting, air-conditioning installations and passenger information systems in the vehicles provided. However, wind deflectors cannot deliver any additional force when the vehicle is stationary.

At present, single-stage and two-stage presses (with a fixed, but calibratable setting) are known from the prior art. In specific cases, Electro-Pneumatically (EP) controlled pressure actuators are already in use. Numerous research projects (and patent applications) address active current collector force regulation as their subject matter. Regulators based upon up to four force sensors or up to four acceleration sensors, arranged at the contact points of the current collector rocker or in the vicinity thereof, are known. To date, there have been no commercially successful products, as the electromagnetic environment is “contaminated”, e.g., by the necessity for glass-fiber connections for the sensors, such that the costs of series production are excessively high.

The disclosed embodiments, therefore, provide a cost-effective device and of a method using such a device, by which a current operating state of an electrically conductive connection or of a contact between a moveable and a stationary part of an electric current transfer system can be identified and evaluated. In particular, by application of the disclosed embodiments in a current collector of a vehicle, it is intended that, e.g., contact strip wear on a current collector rocker be minimized by combined optimization of electrical and mechanical wear. This may be achieved in that the contact strips of the current collector rocker, in the interests of minimum mechanical wear, are operated within a range of limited and minimal contact force, with no resulting increased electrical wear associated with arcing and sparkover caused by impairments in current transmission.

According to the disclosed embodiments, a device incorporates a sensor device for identifying an operating state of an electrically conductive contact by detection of electromagnetic radiation in the form of sparks or electromagnetic crackling, according to a contact force at a contact point between a moveable and a stationary part of an electric current supply. The device according to the disclosed embodiments can particularly be employed in a current collector of a vehicle, to identify the operating state of the contact between the current collector rocker and the contact line.

Optionally, the sensor device of the device according to the disclosed embodiments is configured for the identification of electrical sparks at the contact point, to evaluate the contact force at the contact point.

Alternatively, the sensor device of the device according to the disclosed embodiments may be configured for the identification of electrical crackling (electromagnetic noise) at the contact point, to evaluate the contact force at the contact point.

In the event that sparks are to be identified, the device may optionally comprise a detection unit for the detection of sparks at the contact point, and an evaluation unit which is configured for the evaluation of the sparks at the contact point, e.g., for the counting of sparks in a predefined time period. In a further form, the device can comprise a memory unit which is configured for saving a predefined lower limit of sparks per time period and a predefined upper limit of sparks per time period, a comparator unit which is configured for comparing the number of sparks detected in the predefined time period with the upper limit and the lower limit, and a determination unit which is configured for determining whether the number of sparks detected lies below the lower limit or above the upper limit.

Alternatively, the sensor device of the device according to the disclosed embodiments may be configured for the evaluation of electromagnetic radiation at the electrically conductive contact according to spectrum and magnitude.

Optionally, the device according to the disclosed embodiments may further comprise a regulating device which is configured to regulate the contact force between the moveable and the stationary part of an electric current transfer system, e.g., between the current collector and the contact line, in accordance with measuring parameters measured by the sensor device. By the identification of the operating state of the contact between the current collector and the contact line, it can be evaluated whether the contact force is too small or too great, in comparison with a target contact force. A target contact force lies within a specific range, which is dependent upon factors such as, e.g., the speed of the vehicle, the direction of travel, the position of the current collector in the train formation, environmental parameters (such as, e.g., the formation of ice or atmospheric humidity), whether the vehicle is traveling in a tunnel (and, if so, the tunnel class concerned, as defined by the blockage factor and abrupt changes in cross section), and whether the parking brake is engaged. In a vehicle with a current collector, the control device of which is equipped with a pilot pressure circuit, a pilot pressure in the pilot pressure circuit can be correspondingly adjusted, to regulate the contact force between the current collector rocker and the contact line. An advantage is the resulting avoidance of any unnecessarily high contact force between the current collector and the contact line, thereby extending the service life, particularly of the current collector rocker.

FIG. 2 shows part of a vehicle 10, a current collector 12 incorporating a current collector rocker 14, a contact line 20 and a control device 22, connected to a regulating device 50, according to an exemplary embodiment. As the pressure medium, air flows in an influx direction 90 from a pressure inlet 24 via an air filter 34 into the control device 22.

If the vehicle 10 is in operating mode or standby mode, the control device 22 is engaged by a changeover valve 28a. A changeover valve 28b and a device 30 may constitute monitoring devices. During the operation of the vehicle 10, a specific contact force is required between the current collector 12 and the contact line 20, to ensure a secure transmission of energy from the contact line 20 via the current collector 12 to the vehicle 10. This working pressure may be achieved using a pilot pressure circuit 40, which is in operative connection with a working pressure regulation circuit 60, wherein a regulator (not illustrated) is provided in the pilot pressure circuit 40, to control the working pressure in accordance with a regulated pilot pressure.

A sensor device 52 is provided on the roof of the vehicle 10, in proximity to the current collector 12, to monitor an operating state of the contact between the current collector 12 and the contact line 20, and the parameters measured and evaluated by the sensor device 52 are relayed to a regulating device 50. A regulating device 50 is provided for the delivery of control signals to the regulator. If sparking or crackling between the current collector 12 and the contact line 20 is too strong or too great, it can be concluded that the contact is not ideal. This phenomenon is employed as a mechanism for establishing that the contact force of the current collector 12 on the contact line 20 is either too high or too low. A contact force range is, thus, defined in accordance with the vehicle speed or other parameters, within which optimum or acceptable contact is present. If the contact force lies outside the permissible range, this can be determined and readjusted accordingly. If the contact force between the current collector 12 and the contact line 20 is too low, the regulating device 50 raises the pilot pressure by means of the regulator. If the contact force between the current collector 12 and the contact line 20 is too great, the regulating device 50 reduces the pilot pressure using the regulator.

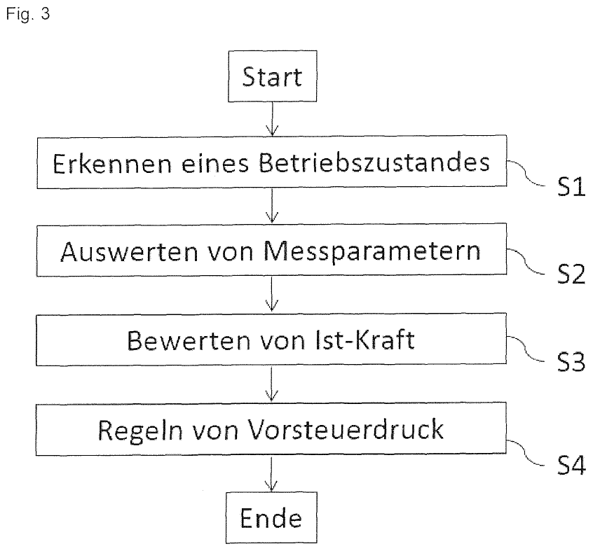

The method according to the disclosed embodiments are now described with reference to the exemplary current collector according to FIG. 2, and the control logic represented in FIG. 3. If, e.g., the vehicle 10 is in operation, an electrical contact is present between the contact line 20 and the current collector rocker 14.

As shown in FIG. 3, the sensor device 52 detects the operating state of the contact between the current collector rocker 14 and the contact line 20, e.g., by identifying sparks/crackling on the electrical contact at S1. The parameters received by the sensor device 52 are then relayed to the regulating device 50 and are evaluated by the regulating device 50 at S2. By the evaluation at S2, the actual force between the current collector rocker 14 and the contact line 20 is evaluated, for the comparison thereof with the target force at S3, which is delimited by an upper limit and a lower limit. The pilot pressure in the pilot pressure circuit 40 is then readjusted in accordance with the evaluation: if the actual force is too low for the current operating situation (i.e., the actual force lies below the lower limit of the target force), the pilot pressure is raised by the regulator; if the actual force is too high for the current operating situation (i.e. the actual force exceeds the upper limit of the target force), the pilot pressure is reduced by the regulator at S4.

### LIST OF REFERENCE NUMBERS

10 Vehicle
12 Current collector
14 Current collector rocker
20 Contact line
22 Control device
24 Pressure inlet
28a, 28b Changeover valve
30 Device
34 Air filter
40 Pilot pressure circuit
50 Regulating device
52 Sensor device
90 Directional arrow

1. A device comprising:
a sensor device for identifying an operating state of an electrically conductive contact by detection of sparks or electromagnetic crackling of electromagnetic radiation to determine a contact force at a contact point between a moveable and a stationary part of an electric current supply.

2. The device of claim 1, wherein the sensor device includes a sensor configured for the detection of the electrical sparks at the electrically conductive contact.

3. The device of claim 1, wherein the sensor device further comprises:
a detection unit for the detection of sparks at the contact point, and
an evaluation unit configured for the evaluation of the sparks at the contact point.

4. The device of claim 3, wherein the evaluation unit further comprises:
a memory unit configured to store a predefined lower limit value of sparks per time period and a predefined upper limit value of sparks per time period;
a comparator unit configured to compare the number of sparks detected in the predefined time period with the upper limit value and the lower limit value; and
a determination unit configured to determine whether the number of sparks detected lies below the lower limit value or above the upper limit value.

5. The device of claim 1, wherein the sensor device includes a sensor which is configured to detect electrical crackling at the electrically conductive contact.

6. The device of claim 1, wherein the sensor device is further configured to evaluate electromagnetic radiation at the electrically conductive contact based on spectrum and magnitude.

7. The device as claimed in claim 1, further comprises a regulating device configured to regulate a contact force between a moveable and a stationary part of an electric current transfer system based on the measuring parameters measured by the sensor device.

8. The device claim 7, wherein the regulating device is configured to regulate a current pilot pressure of a current collector, wherein the device is configured to determine the contact force between the current collector of an electric locomotive and a contact line.

9. The device of claim 8, wherein the regulating device is further configured to regulate the pilot pressure of the current collector within a predefined range, wherein the regulating device raises the pilot pressure in response to the lower limit value being undershot, and reduces the pilot pressure in response to the upper limit value being exceeded.

10. A method for regulating a contact force between a moveable and a stationary part of an electric current supply, the method comprising:
detecting electromagnetic radiation at the contact between the moveable and the stationary part of an electric current supply;
evaluating relevant parameters for the contact quality; and
regulating a parameter for the control of the optimum contact force based on the evaluation.

11. The method of claim 10, wherein the contact force between a current collector of an electric locomotive and a contact line is regulated based on the evaluation, wherein, so as to regulate the pilot pressure of the current collector.

12. The method of claim 11, wherein the pilot pressure of the current collector is regulated within a predefined range, wherein the pilot pressure is raised in response to the contact force having undershot a lower limit, and the pilot pressure is reduced in response to the contact force having exceeded an upper limit.

13. A method for regulating a contact force between a moveable and a stationary part of an electric current supply, the method comprising:
detecting electromagnetic radiation at the contact between the moveable and the stationary part of an electric current supply;
evaluating relevant parameters for the contact quality; and
regulating a parameter for control of an optimization curve for mechanical and electrical wear of the moveable part based on with the evaluation.

14. The method of claim 13, wherein an optimization curve for the mechanical and electrical wear of a current collector is regulated in accordance with the evaluation.
